(19) United States
(12) Patent Application Publication
(10) Pub. No.: US 2022/0388378 A1
(43) Pub. Date: Dec. 8, 2022

(54) VEHICULAR SLIDE DOOR APPARATUS

(71) Applicant: AISIN CORPORATION, Kariya (JP)

(72) Inventors: Akinori SUZUKI, Kariya-shi (JP); Shinji KAZAMA, Kariya-shi (JP); Taishi ISONO, Kariya-shi (JP)

(73) Assignee: AISIN CORPORATION, Kariya (JP)

(21) Appl. No.: 17/664,913

(22) Filed: May 25, 2022

(30) Foreign Application Priority Data
Jun. 8, 2021 (JP) 2021-096141

(51) Int. Cl. B60J 5/06; B60J 5/04; E05D 15/06; E05D 15/10

(52) U.S. Cl. CPC B60J 5/06; B60J 5/047; E05D 15/0621; E05D 15/1047; E05Y 2201/684; E05Y 2900/531; E05D 2015/1057

(57) ABSTRACT

A vehicular slide door apparatus includes a guide rail forming a sliding path. A cutout portion in a side wall portion of the sliding path forms an insertion opening for a guide roller. The apparatus includes a fixing portion at a first end portion in the cutout portion, a positioning portion at a second end portion in the cutout portion, a closing member that includes a fixed end fixed to the fixing portion and a free end positioned by the positioning portion and that closes the insertion opening, and a fulcrum forming portion forming a rotation fulcrum for the closing member. The fulcrum forming portion generates biasing force of displacing the free end outward. The free end is positioned in contact against the positioning portion located on an outer side of the sliding path. Thereby, the free end and the side wall portion form a continuous sliding contact surface.

### CROSS REFERENCE TO RELATED APPLICATIONS

This application is based on and claims priority under 35 U.S.C. § 119 to Japanese Patent Application No. 2021-096141, filed on Jun. 8, 2021, the entire content of which is incorporated herein by reference.

### TECHNICAL FIELD

This disclosure generally relates to a vehicular slide door apparatus.

### BACKGROUND DISCUSSION

Generally, a vehicular slide door apparatus includes a guide rail and a guide roller unit linked to the guide rail. In other words, the guide rail forms a sliding path extending in an opening-closing operation direction of a slide door. The guide rail guides a guide roller arranged in the sliding path, in an extending direction thereof. The slide door apparatus is configured in such a way as to open and close a door opening provided in a vehicle body by allowing the vehicle body to support the slide door via the guide rail and the guide roller unit.

For example, in a slide door apparatus described in JP1998-315776A (Reference 1), a guide roller insertion opening that opens to a lower side of a guide rail is provided at an intermediate position in a sliding path formed of the guide rail. In the insertion opening, a bracket protruding to a lateral side of the guide rail is provided. After the guide roller is inserted, a clip is attached to the bracket, and thereby, the insertion opening is closed.

However, in the above-described conventional configuration, the bracket protruding to a lateral side of the guide rail tends to restrict designing of the slide door apparatus. This causes a problem that mountability thereof on a vehicle is lowered.

A need thus exists for a vehicular slide door apparatus which is not susceptible to the drawback mentioned above.

### SUMMARY

A vehicular slide door apparatus that solves the above-described problem includes a guide rail. The guide rail forms a sliding path extending in an opening-closing operation direction of a slide door, and guides, in an extending direction of the sliding path, a guide roller arranged in the sliding path. A cutout portion provided in a side wall portion of the sliding path forms an insertion opening to the sliding path, for the guide roller. The vehicular slide door apparatus includes a fixing portion, a positioning portion, a closing member, and a fulcrum forming portion. The fixing portion is arranged at a first end portion in the cutout portion in the extending direction. The positioning portion is arranged at a second end portion in the cutout portion in the extending direction. The closing member includes a fixed end fixed to the fixing portion and a free end positioned by the positioning portion, and is arranged at the cutout portion, thereby closing the insertion opening. The fulcrum forming portion forms a rotation fulcrum for the closing member at a longitudinal-direction position between the fixed end and the free end by fixing of the fixed end to the fixing portion. The fulcrum forming portion generates biasing force in a direction of displacing the free end outward in a width direction of the sliding path. The free end of the closing member is positioned in contact against the positioning portion located on a width-direction outer side of the sliding path. Thereby, the free end of the closing member and the side wall portion of the sliding path are configured to form a continuous sliding contact surface for the guide roller.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a schematic illustration of a configuration of a slide door apparatus;

FIG. 2 is a perspective view of the slide door apparatus;

FIG. 3 is a plan view of the slide door apparatus;

FIG. 4 is a cross-sectional view of the slide door apparatus;

FIG. 5 is an exploded perspective view of the slide door apparatus;

FIG. 6 is a cross-sectional view of the slide door apparatus;

FIG. 7 is a cross-sectional view of the slide door apparatus;

FIG. 8 is a cross-sectional view of the slide door apparatus; and

FIG. 9 is a cross-sectional view of the slide door apparatus.

### DETAILED DESCRIPTION

The following describes one embodiment concerning a vehicular slide door apparatus, with reference to the drawings.

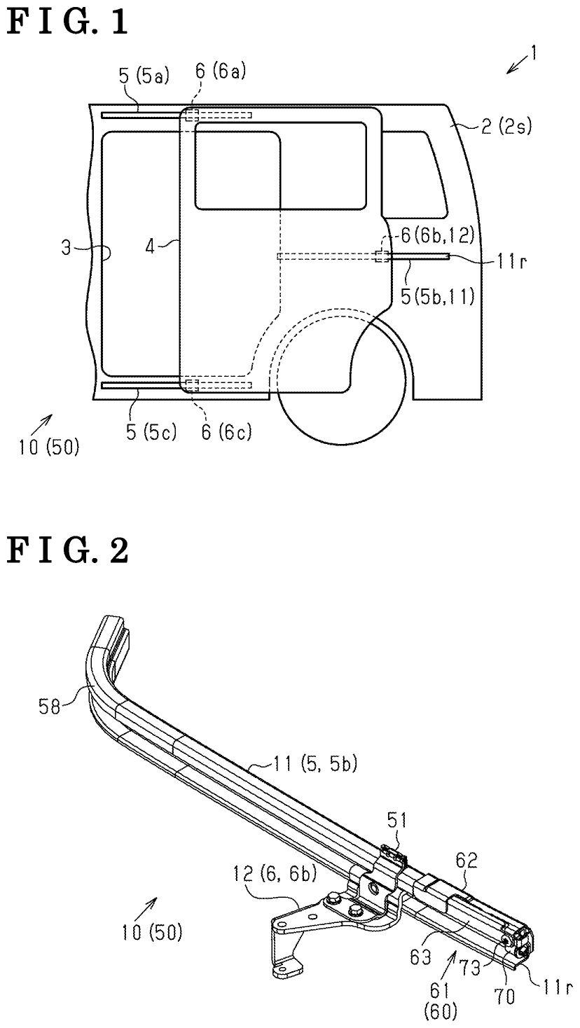

As illustrated in FIG. 1, a vehicle 1 of this embodiment includes a slide door 4 for opening and closing a door opening 3 provided in a side surface 2s of a vehicle body 2. Specifically, the vehicle 1 includes a plurality of guide rails 5a to 5c extending in a front-rear direction (the left-right direction in FIG. 1) and a plurality of guide roller units 6a to 6c linked to the respective guide rails 5. The slide door 4 of this embodiment is supported by the side surface 2s of the vehicle body 2 via the respective guide rails 5 and the respective guide roller units 6.

The respective guide rails 5 and the respective guide roller units 6 allow link positions of the respective guide roller units 6 to the respective guide rails 5 to be moved relative to the respective guide rails 5 along extending directions of the respective guide rails 5. In the vehicle 1 of this embodiment, the slide door apparatus 10 that enables opening-closing operation of the slide door 4 provided at the door opening 3 is thereby formed.

In other words, in the slide door apparatus 10 according to this embodiment, the slide door 4 is moved to a vehicle front side (the left side in FIG. 1), and is thereby in a fully closing state of closing the door opening 3. The slide door 4 is configured in such a way as to be moved to a vehicle rear side (on the right side in this figure), and be thereby in an opening state where an occupant of the vehicle 1 gets on and off through the door opening 3.

(Guide Roller Insertion Structure of Guide Rail)

Next, a guide roller insertion structure of each guide rail 5 constituting the slide door apparatus 10 according to this embodiment is described.

Hereinafter, for convenience of description, constituents illustrated in the drawings concern only the guide rail 5b and the guide roller unit 6b provided on a rear side of the door opening 3 and at a height near a belt line, i.e., a center rail 11 and a center roller unit 12. The guide rails 5a and 5c and the guide roller units 6a and 6c arranged above and below the door opening 3 include guide roller insertion structures substantially similar to that of the center rail 11, and thus, their illustrations in the drawings are omitted.

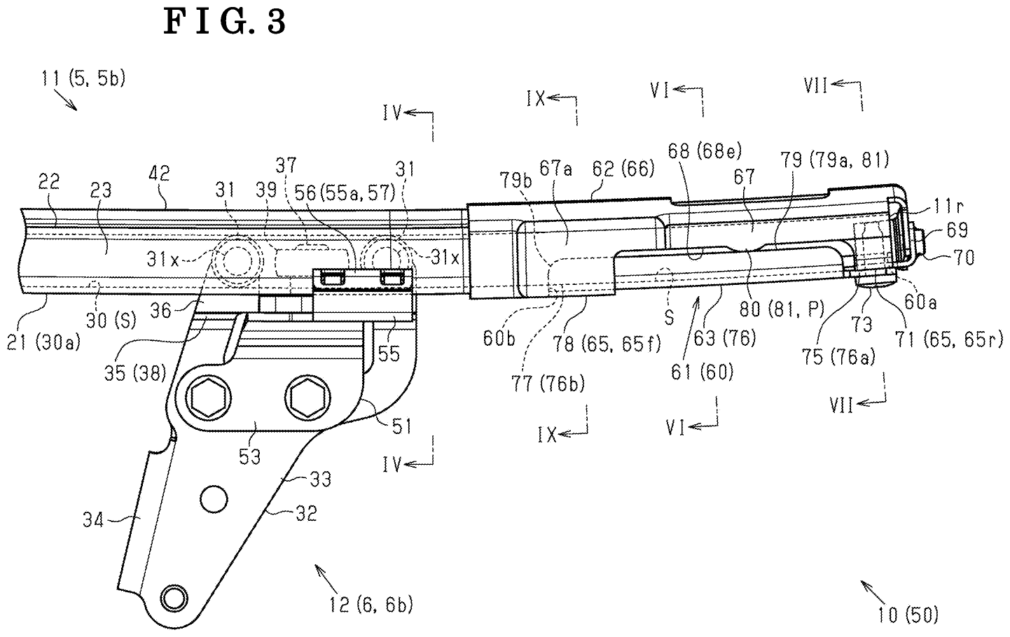

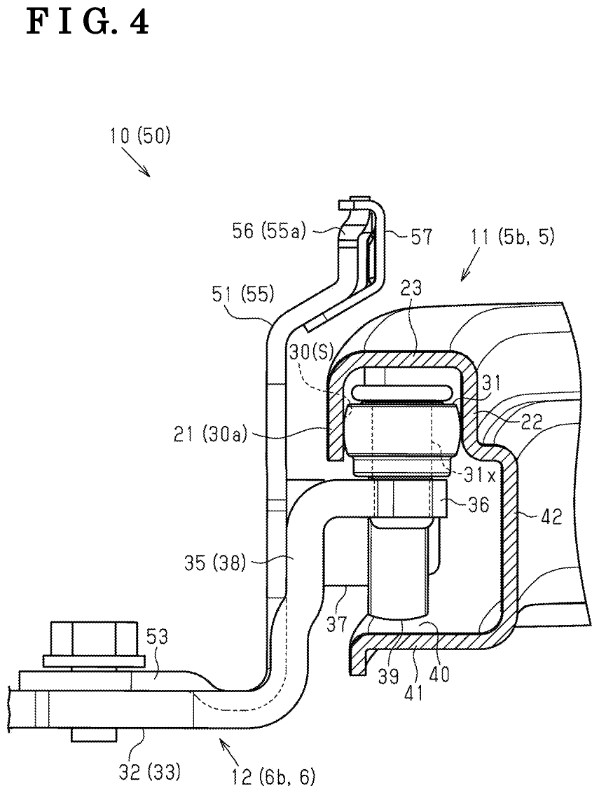

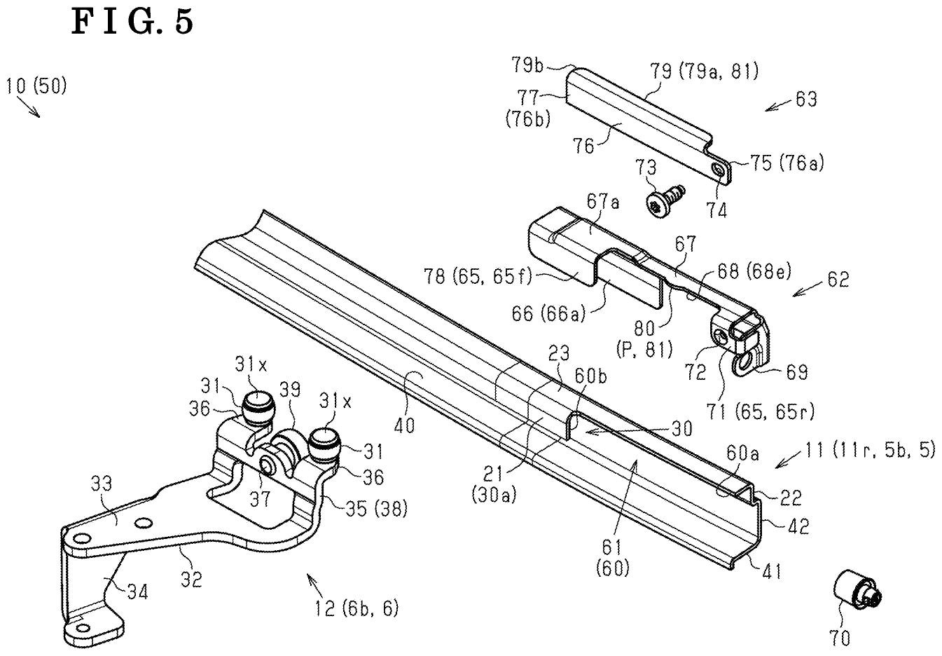

As illustrated in FIG. 2 to FIG. 5, the center rail 11 of this embodiment includes a first side wall portion 21 and a second side wall portion 22 that face each other in a rail width direction (that is the up-down direction in FIG. 3, and is the left-right direction in FIG. 4). The center rail 11 includes an upper wall portion 23 connecting, to each other, upper ends of the first side wall portion 21 and the second side wall portion 22. In the slide door apparatus 10 according to this embodiment, each of the guide rails 5 including the center rail 11 includes the first side wall portion 21, the second side wall portion 22, and the upper wall portion 23 that are described above. Each of the guide rails 5 of this embodiment is configured in such a way as to form a sliding path 30 that is inside a U-shaped cross section formed by the first side wall portion 21, the second side wall portion 22, and the upper wall portion 23 and that extends in an opening-closing operation direction of the slide door 4 (in the left-right direction in FIG. 3).

In the slide door apparatus 10 according to this embodiment, each of the guide roller units 6 including the center roller unit 12 includes a guide roller 31 arranged in the sliding path 30 formed by the corresponding guide rail 5. Specifically, each of these guide rollers 31 is rotatably shaft-supported by a support shaft 31x extending in the up-down direction. Each of the guide rollers 31 is arranged in the sliding path 30, in a state of sliding on and contacting with the first side wall portion 21 and the second side wall portion 22. Thus, each guide rail 5 is configured in such a way as to guide the guide roller 31 in the extending direction of the sliding path 30.

Specifically, as illustrated in FIG. 3 to FIG. 5, the center roller unit 12 of this embodiment includes a support arm 32 rotatably linked to the slide door 4. In the slide door apparatus 10 according to this embodiment, the support arm 32 is formed by plastic working of a metal plate. In the slide door apparatus 10 according to this embodiment, the center rail 11 is fixed to a vehicle body 2 in a state where the first side wall portion 21 as one of the first side wall portion 21 and the second side wall portion 22 that form the sliding path 30 having the substantially U-shaped cross section open to a lower side of the center rail 11 is arranged on an outer side in the vehicle width direction. Thereby, the slide door apparatus 10 according to this embodiment is configured in such a way that the support arm 32 of the roller unit 12 extends to an outer side (in FIG. 4, the left side) of the first side wall portion 21 in the width direction of the sliding path 30 formed by the center rail 11.

Specifically, the support arm 32 includes a substantially flat plate-shaped arm body 33, a door link portion 34 provided at one end of the arm body 33, and a roller support portion 35 provided at an opposite end of the arm body 33. In the support arm 32 of this embodiment, the door link portion 34 is provided in a shape in which one end part of the arm body 33 is bent downward. The roller support portion 35 is provided in a shape in which an opposite end part of the arm body 33 is bent upward. The roller support portion 35 includes, at its upper end part, a flange portion 36 that is arranged on a lower side of the sliding path 30 formed by the center rail 11, i.e., at a position to which the U-shaped cross section opens. The center roller unit 12 of this embodiment is configured in such a way that the support shaft 31x of the guide roller 31 is arranged at the flange portion 36.

More specifically, the center roller unit 12 of this embodiment includes a pair of the guide rollers 31 and 31 arranged to each other in the extending direction of the sliding path 30 formed by the center rail 11. The center roller unit 12 includes, at a position between both the guide rollers 31 and 31, a support shaft 37 extending in a direction substantially perpendicular to each of the support shafts 31x and 31x. The support shaft 37 is provided at a standing portion 38 included in the roller support portion 35 and extending upward from the arm body 33. The center roller unit 12 of this embodiment includes a load roller 39 freely rotatably shaft-supported by the support shaft 37. The center rail 11 of this embodiment includes a lower wall portion 41 forming a rolling path 40 for the load roller 39.

Specifically, the center rail 11 of this embodiment includes an extension wall 42 extending downward in a form of being continuous with the second side wall portion 22. The lower wall portion 41 extends in the extending direction of the sliding path 30, in a form of extending from a lower end of the extension wall 42 to a position on a lower side of the sliding path 30. Thereby, the center rail 11 of this embodiment is configured in such a way that the load roller 39 provided in the center roller unit 12 contacts, from an upper side, against the lower wall portion 41 located on a lower side of the sliding path 30.

In other words, in the slide door apparatus 10 according to this embodiment, the center rail 11 and the center roller unit 12 move relative to each other in a state where the load roller 39 of the center roller unit 12 rolls on the rolling path 40 formed by the lower wall portion 41 of the center rail 11. Thereby, the slide door apparatus 10 according to this embodiment is configured in such a way that the center rail 11 supports a load of the slide door 4 linked to the center roller unit 12, and thereby, the slide door 4 smoothly makes opening-closing operation.

The slide door apparatus 10 according to this embodiment is configured as a power slide door apparatus 50 including a drive source and opening and closing the slide door 4. The center roller unit 12 is provided with a link member 51 for transmitting drive force to the center roller unit 12.

Specifically, as illustrated in FIG. 3 and FIG. 4, in the center roller unit 12 of this embodiment, the link member 51 is provided at the support arm 32. Specifically, the link member 51 includes a fixed portion 53 fixed to the arm body 33, and an upward-extending portion 55 extending upward along the standing portion 38 of the roller support portion 35, and is thereby bent-plate-shaped, i.e., substantially L-shaped. In the link member 51 of this embodiment, the upward-extending portion 55 is extended upward in a state of facing the first side wall portion 21 included in the center rail 11 and constituting a side wall portion 30a of the sliding path 30, and thereby, a distal end portion 55a of the upward-extending portion 55 is arranged on an upper side of the center rail 11. The link member 51 of this embodiment includes a cable link portion 56 provided, for an unillustrated drive cable, at the distal end portion 55a of the upward-extending portion 55.

In other words, in the slide door apparatus 10 according to this embodiment, the drive cable is arranged on an upper side of the center rail 11. The drive cable is driven by an unillustrated actuator, and thereby slides along the extending direction of the center rail 11. The cable link portion 56 of the link member 51 of this embodiment is structured in such a way as to sandwich the drive cable between a fixing member 57 having an external shape of a substantially flat plate and the distal end portion 55a of the upward extending portion 55, and thereby fixes the drive cable to the link member 51. Thereby, the slide door apparatus 10 according to this embodiment is configured in such a way that the slide door 4 makes opening-closing operation in the extending direction of the center rail 11, based on drive force transmitted to the center roller unit 12 via the drive cable and the link member 51.

As illustrated in FIG. 1 and FIG. 2, in the slide door apparatus 10 according to this embodiment, each of the guide rails 5 including the center rail 11 includes, near its front end portion, a curved shape portion 58. In other words, each of the curved shape portions 58 curves, to a vehicle-width-direction inner side toward a vehicle front side, the sliding path 30 formed by the guide rail 5. Thereby, the slide door apparatus 10 according to this embodiment is configured in such a way that the slide door 4 supported by the side surface 2s of the vehicle body 2 via each of the guide rails 5 and the guide roller units 6 makes opening-closing operation without interfering with the vehicle body 2.

As illustrated in FIG. 3 and FIG. 5 to FIG. 9, the center rail 11 of this embodiment includes a cutout portion 60 provided in the first side wall portion 21 that is one of the first and second side wall portions 21 and 22 constituting the sliding path 30 and that is arranged on a vehicle-width-direction outer side. Specifically, the cutout portion 60 is provided in a rear end portion 11r of the center rail 11. In the center rail 11 of this embodiment, the cutout portion 60 forms an insertion opening 61 for insertion of the respective guide rollers 31 and 31 into the sliding path 30.

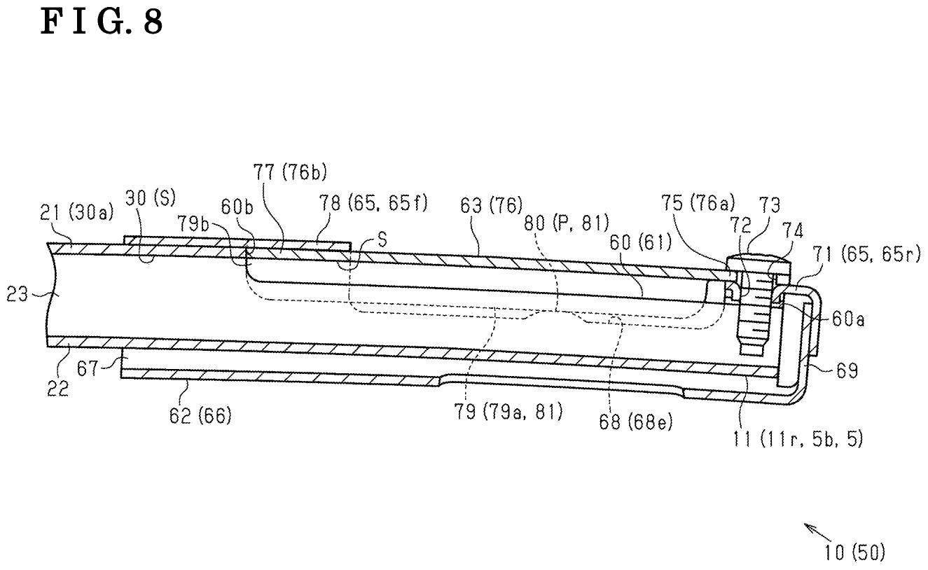

Specifically, the cutout portion 60 of this embodiment is provided, in the rear end portion 11r of the center rail 11, in a form where a part of the first side wall portion 21 forming the side wall portion 30a of the sliding path 30 and a part of the upper wall portion 23 connected to the first side wall portion 21 are cut out. The cutout portion 60 extends from an extending-direction end position of the rear end portion 11r of the center rail 11 to a front side (the left sides in FIG. 3 and FIG. 8). The slide door apparatus 10 according to this embodiment includes a bracket 62 that is fixed to the rear end portion 11r of the center rail 11 in a state of partially covering the cutout portion 60. The center rail 11 of this embodiment is configured in such a way that an opening of the cutout portion 60 facing toward a width-direction outer side of the sliding path 30 via the bracket 62 is used as the insertion opening 61 for the respective guide rollers 31 and 31 constituting the center roller unit 12.

The slide door apparatus 10 according to this embodiment includes a closing member 63 arranged at the cutout portion 60, in a state of being held by the bracket 62. In other words, the closing member 63 is attached to the center rail 11 after the guide rollers 31 and 31 are inserted into the sliding path 30, i.e., after the center roller unit 12 is linked to the center rail 11. The slide door apparatus 10 according to this embodiment is configured in such a way that the insertion opening 61 for the guide rollers 31 and 31 is closed with the closing member 63.

More specifically, the bracket 62 of this embodiment has an external shape like a cover fixed to the rear end portion 11r, in a state of covering an upper portion of the center rail 11. Specifically, the bracket 62 includes a first standing plate-shaped portion 65 and a second standing plate-shaped portion 66 that are on width-direction outer sides of the sliding path 30 formed by the first side wall portion 21 and the second side wall portion 22 and that are arranged at positions covering the first side wall portion 21 and the second side wall portion 22. The bracket 62 includes a lateral plate-shaped portion 67 arranged, in a state of being along the upper wall portion 23, at a position covering an upper portion of the upper wall portion 23. In the bracket 62 of this embodiment, the second standing plate-shaped portion 66 covering a lateral side of the second side wall portion 22 extends as far as a position partially covering the extension wall 42 included in the center rail 11 and located on a lower side of the second side wall portion 22. The bracket 62 of this embodiment is configured in such a way that a downward-extending portion 66a provided in the second standing plate-shaped portion 66 is fixed to the extension wall 42 of the center rail 11 by welding or the like.

The bracket 62 of this embodiment includes a cutout portion 68 provided in a form where a part of the first standing plate-shaped portion 65 and a part of the lateral plate-shaped portion 67 connected to the first standing plate-shaped portion 65 are cut out. The bracket 62 of this embodiment is fixed to the center rail 11 in a state where the cutout portion 68 overlaps with the cutout portion 60 provided in the rear end portion 11r of the center rail 11. The slide door apparatus 10 according to this embodiment is configured in such a way that an area faced by the cutout portion 60 of the center rail 11 outward in the width direction of the sliding path 30 via the cutout portion 68 provided in the bracket 62 is used as the insertion opening 61 for the respective guide rollers 31 and 31.

Specifically, in the bracket 62 of this embodiment, the first standing plate-shaped portion 65 is configured in such a way as to include a front-side standing plate-shaped portion 65f and a rear-side standing plate-shaped portion 65r that are arranged apart from each other in the extending direction of the center rail 11 and between which the cutout portion 68 is sandwiched. The bracket 62 of this embodiment is configured in such a way as to be fixed to the center rail 11 in a state where the front-side standing plate-shaped portion 65f and the rear-side standing plate-shaped portion 65rcover both ends of the cutout portion 60 extending in the extending direction of the center rail 11.

In other words, in the bracket 62 of this embodiment, the rear-side standing plate-shaped portion 65r is arranged at a position covering a first end portion 60a that is a rear-side end portion in the cutout portion 60 of the center rail 11 in the extending direction of the sliding path 30. In the bracket 62 of this embodiment, the front-side standing plate-shaped portion 65f is arranged at a position covering a second end portion 60b that is a front-side end portion in the cutout portion 60 of the center rail 11 in the extending direction of the sliding path 30.

The bracket 62 of this embodiment includes an end portion 69 arranged at an end position where the rear end portion 11r of the center rail 11 opens in the extending direction, in a form where rear end portions of the rear-side standing plate-shaped portion 65r and the second standing plate-shaped portion 66 are bent inward in the width direction of the sliding path 30 of the center rail 11. The end portion 69 is provided with a stopper member 70 that contacts against the support arm 32 included in the center roller unit 12 and supporting the respective guide rollers 31 and 31 arranged in the sliding path 30 formed by the center rail 11 and that thereby restricts relative movement of the support arm 32 along the extending direction.

In the bracket 62 of this embodiment, the rear-side standing plate-shaped portion 65r forms a fixing portion 71 for the closing member 63, at the first end portion 60a of the cutout portion 60 provided in the center rail 11. Specifically, the bracket 62 of this embodiment includes an attachment hole 72 provided in the rear-side standing plate-shaped portion 65r. In the slide door apparatus 10 according to this embodiment, a screw member 73 is screwed into the attachment hole 72 from a width-direction outer side of the sliding path 30 formed by the center rail 11. The closing member 63 is provided with a through hole 74 through which the screw member 73 is inserted. The slide door apparatus 10 according to this embodiment is configured in such a way that the closing member 63 is fixed, based on fastening force of the screw member 73, to the fixing portion 71 formed by the rear-side standing plate-shaped portion 65r of the bracket 62.

Specifically, the closing member 63 of this embodiment includes a fixed end 75 associated with the fixing portion 71 formed at the first end portion 60a of the cutout portion 60 as described above, and has a long, substantially plate-like external shape for arrangement at the cutout portion 60. Specifically, the closing member 63 includes a vertical wall portion 76 that has a long, substantially flat-plate shape and that is arranged, at the cutout portion 60, in a state of extending in the extending direction of the center rail 11. The closing member 63 of this embodiment is configured in such a way that a first end portion 76a on one longitudinal-direction side in the vertical wall portion 76 is the fixed end 75 fixed to the fixing portion 71 formed by the bracket 62.

In the closing member 63 of this embodiment, a second end portion 76b on a longitudinal-direction opposite side in the vertical wall portion 76 is arranged at the second end portion 60b of the cutout portion 60. The second end portion 76b of the vertical wall portion 76 arranged at the second end portion 60b of the cutout portion 60, and the first side wall portion 21 included in the center rail 11 and forming the side wall portion 30a of the sliding path 30 form a continuous sliding contact surface S for the guide rollers 31. Thereby, the slide door apparatus 10 according to this embodiment is configured in such a way that the guide rollers 31 and 31 arranged in the sliding path 30 can move, in a state of sliding along the vertical wall portion 76, as far as a position where the insertion opening 61 closed by the closing member 63 is formed.

Specifically, the closing member 63 of this embodiment is attached to the center rail 11, in a form where the second end portion 76b of the vertical wall portion 76 is inserted into the second end portion 60b included in the cutout portion 60 and covered with the front-side standing plate-shaped portion 65f of the bracket 62. In the closing member 63, the second end portion 76b of the vertical wall portion 76 is configured as a free end portion 77 that is not fixed to other members. In the closing member 63, the second end portion 76b of the vertical wall portion 76 contacts against the front-side standing plate-shaped portion 65f of the bracket 62, in a state where the first end portion 76a included in the vertical wall portion 76 and constituting the fixed end 75 is fixed to the fixing portion 71 formed at the first end portion 60a of the cutout portion 60. Thereby, in the closing member 63 according to this embodiment, the second end portion 76b included in the vertical wall portion 76 and configured as the free end portion 77 is positioned at the second end portion 60b of the cutout portion 60 by using as a positioning portion 78 the front-side standing plate-shaped portion 65f of the bracket 62.

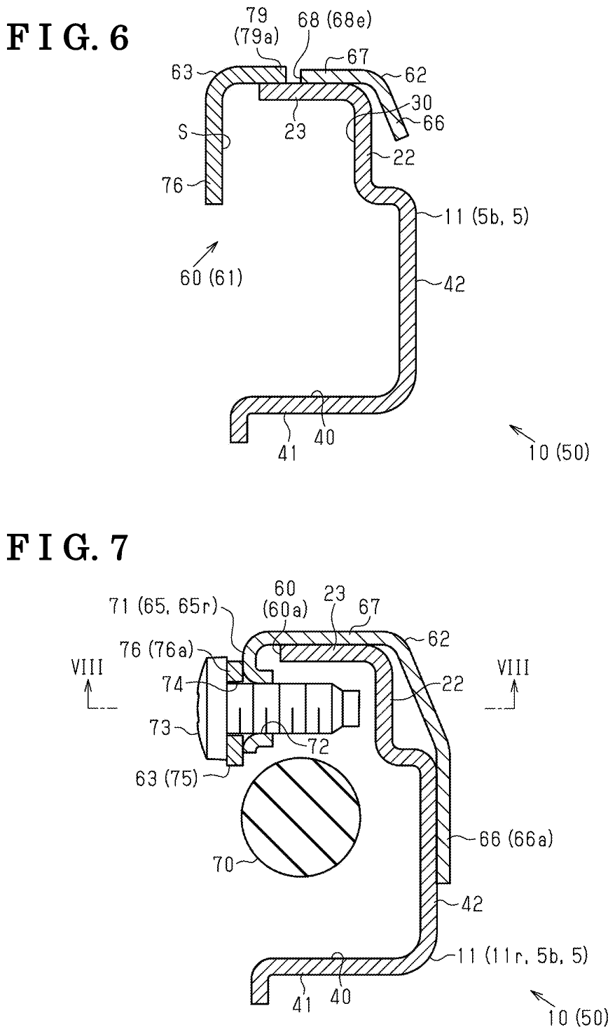

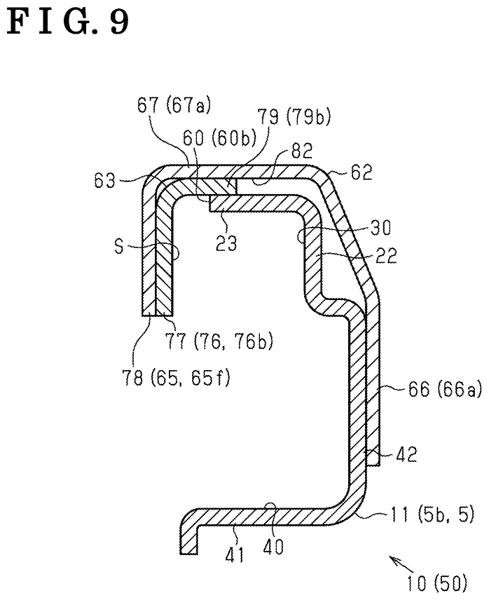

More specifically, in a state of being arranged at the cutout portion 60, the closing member 63 of this embodiment includes a plate-shaped width-direction extending portion 79 extending from an upper end of the vertical wall portion 76 to a width-direction inner side of the sliding path 30 (that is an upper side in FIG. 3, and is right sides in FIG. 6 and FIG. 9). In other words, in the slide door apparatus 10 according to this embodiment, the closing member 63 has a bent-plate shape having a substantially L-shaped cross section and arranged in a state where the vertical wall portion 76 and the width-direction extending portion 79 are substantially perpendicular to each other. Thereby, the closing member 63 of this embodiment is configured in such a way that a distal end 79a of the width-direction extending portion 79 extending inward in the width direction of the sliding path 30 and an upper edge portion 68e included in the cutout portion 68 and provided in the lateral plate-shaped portion 67 of the bracket 62 are arranged at positions facing each other.

The bracket 62 of this embodiment includes, at the upper edge portion 68e of the cutout portion 68, a protrusion portion 80 protruding outward in the width direction of the sliding path 30. In the slide door apparatus 10 according to this embodiment, the protrusion portion 80 includes a substantially semicircular flat plate shape continuous with the lateral plate-shaped portion 67 forming the upper edge portion 68e of the cutout portion 68. The closing member 63 of this embodiment is configured in such a way that the distal end 79a of the width-direction extending portion 79 contacts against a substantially semicircular distal part set in the protrusion portion 80.

In the slide door apparatus 10 according to this embodiment, a rotation fulcrum P for the closing member 63 is formed at a position where the protrusion portion 80 provided in the bracket 62 contacts against the distal end 79a of the width-direction extending portion 79 constituting the closing member 63. Thereby, the slide door apparatus 10 according to this embodiment is configured in such a way that the protrusion portion 80 included in the bracket 62 and contacting against the width-direction extending portion 79 of the closing member 63 from an inner side in the width direction of the sliding path 30 functions as a fulcrum forming portion 81 along with the width-direction extending portion 79.

Specifically, the fulcrum forming portion 81 forms the rotation fulcrum P for the closing member 63 at a longitudinal-direction position between the fixed end 75 and the free end 77 by fixing the fixed end 75 of the closing member 63 to the fixing portion 71 located at the first end portion 60a of the cutout portion 60. Thereby, in the closing member 63, biasing force is generated in a direction of displacing, outward in the width direction of the sliding path 30 around the rotation fulcrum P, the second end portion 76b included in the vertical wall portion 76 and arranged at the second end portion 60b of the cutout portion 60. In the closing member 63 of this embodiment, based on the biasing force, the second end portion 76b of the vertical wall portion 76 contacts against the front-side standing plate-shaped portion 65f included in the bracket 62 and located on an outer side of the second end portion 76b of the vertical wall portion 76 in the width direction of the sliding path 30. Thereby, the slide door apparatus 10 according to this embodiment is configured in such a way that the free end 77 included in the closing member 63 and arranged at the second end portion 60b of the cutout portion 60 is positioned.

More specifically, in the slide door apparatus 10 according to this embodiment, the front-side standing plate-shaped portion 65f that is included in the bracket 62, that is arranged at the second end portion 60b of the cutout portion 60, and that thereby forms the positioning portion 78 has an external shape of a substantially flat plate. The front-side standing plate-shaped portion 65f is arranged at a position on an outer side of the first side wall portion 21 in the width direction of the sliding path 30, in a state of contacting against the first side wall portion 21 that is included in the center rail 11 and that forms the side wall portion 30a of the sliding path 30. In the slide door apparatus 10 according to this embodiment, the vertical wall portion 76 of the closing member 63 is set in such a way as to have a thickness substantially equal to that of the first side wall portion 21 of the center rail 11. Thereby, in the closing member 63 of this embodiment, the second end portion 76b included in the vertical wall portion 76 and positioned in contact against the front-side standing plate-shaped portion 65f of the bracket 62 is located at a position continuous and contacting with the first side wall portion 21 of the center rail 11. In other words, the free end 77 arranged at the second end portion 60b of the cutout portion 60 and the first side wall 21 included in the center rail 11 and forming the side wall 30a of the sliding path 30 are configured in such a way as to form the continuous sliding contact surface S for the guide rollers 31.

The bracket 62 of this embodiment is configured in such a way as to sandwich the width-direction extending portion 79 of the closing member 63 between the lateral plate-shaped portion 67 and the upper wall portion 23 of the center rail 11. Thereby, in the slide door apparatus 10 according to this embodiment, the closing member 63 arranged at the cutout portion 60 is positioned in the up-down direction of the guide rail 5. Specifically, the free end 77 of the closing member 63 arranged at the second end portion 60b of the cutout portion 60 is configured in such a way that an up-down-direction position of the free end 77 is fixed.

Specifically, in the bracket 62 of this embodiment, a bulging portion 67a provided in the lateral plate-shaped portion 67 is configured in such a way as to form a gap 82 between the bulging portion 67a and the upper wall portion 23 of the center rail 11 located on a lower side of the bulging portion 67a. In the closing member 63 of this embodiment, when the second end portion 76b of the vertical wall portion 76 is arranged at the second end portion 60b of the cutout portion 60, a longitudinal end portion 79b of the width-direction extending portion 79 located on an upper side of the second end portion 76b is inserted into the gap 82 between the lateral plate-shaped portion 67 and the upper wall portion 23. Thereby, the slide door apparatus 10 according to this embodiment is configured in such a way that at the second end portion 60b of the cutout portion 60, the width-direction extending portion 79 of the closing member 63 is sandwiched between the upper wall portion 23 of the center rail 11 and the lateral plate-shaped portion 67 of the bracket 62.

The bracket 62 of this embodiment has a function of suppressing falling of the closing member 63 by sandwiching the width-direction extending portion 79 of the closing member 63 between the lateral plate-shaped portion 67 and the upper wall portion 23 of the center rail 11.

In other words, as described above, the closing member 63 of this embodiment is configured in such a way that the protrusion portion 80 provided in the bracket 62 contacts against the distal end 79a of the width-direction extending portion 79 extending from the upper end of the vertical wall portion 76 inward in the width direction of the sliding path 30. At this time, the reaction force acts on the width-direction extending portion 79 of the closing member 63 in a direction in which the protrusion portion 80 included in the bracket 62 and contacting against the distal end 79a of the width-direction extending portion 79 presses back the width-direction extending portion 79. There is a possibility that, in the closing member 63 of this embodiment, the reaction force in the direction of pressing back the width-direction extending portion 79 acts in a direction of tilting the vertical wall portion 76 in a form of displacing an upper end part of the vertical wall portion 76 outward in the width direction.

However, in the slide door apparatus 10 according to this embodiment, the width-direction extending portion 79 of the closing member 63 is sandwiched between the upper wall portion 23 of the center rail 11 and the lateral plate-shaped portion 67 of the bracket 62, and thereby, tilting of the width-direction extending portion 79 is restricted. Tilting of the vertical wall portion 76 of the closing member 63 provided integrally with the width-direction extending portion 79 is also restricted. Thereby, the slide door apparatus 10 according to this embodiment is configured in such a way that the reaction force acting on the width-direction extending portion 79 of the closing member 63 can be efficiently converted into biasing force in a direction of displacing the free end 77 of the closing member 63 outward in the width direction of the sliding path 30.

Next, an effect of this embodiment is described.

In other words, in the slide door apparatus 10 according to this embodiment, the first end portion 76a included in the vertical wall portion 76 and forming the fixed end 75 of the closing member 63 is fixed to the fixing portion 71 arranged at the first end portion 60a of the cutout portion 60. Thereby, the rotation fulcrum P for the closing member 63 is formed at the longitudinal-direction position between the first end portion 76a of the vertical wall portion 76 and the second end portion 76b included in the vertical wall portion 76 and forming the free end 77 of the closing member 63. Biasing force of displacing, around the rotation fulcrum P outward in the width direction of the sliding path 30, the second end portion 76b included in the vertical wall portion 76 and arranged at the second end portion 60b of the cutout portion 60 is generated in the closing member 63. Thereby, the second end portion 76b of the vertical wall portion 76 is positioned in contact against the positioning portion 78 located on a width-direction outer side of the sliding path 30, and thus, the second end portion 76b of the vertical wall portion 76 and the side wall portion 30a of the sliding path 30 form the continuous sliding contact surface S for the guide rollers 31.

Next, advantageous effects of this embodiment are described.

(1) In the cutout portion 60 provided in the side wall portion 30a of the sliding path 30 formed by the guide rail 5, the slide door apparatus 10 includes the fixing portion 71 arranged at the first end portion 60a and the positioning portion 78 arranged at the second end portion 60b. The slide door apparatus 10 includes the closing member 63 arranged at the cutout portion 60 and including the fixed end 75 associated with the fixing portion 71 and the free end 77 positioned by the positioning portion 78. The slide door apparatus 10 includes the fulcrum forming portion 81 forming the rotation fulcrum P at the longitudinal-direction position between the fixed end 75 and the free end 77 of the closing member 63, and generating biasing force in a direction in which the free end 77 is displaced outward in the width direction of the sliding path 30. The free end 77 of the closing member 63 is positioned in contact against the positioning portion 78 located on a width-direction outer side of the sliding path 30, and thereby, the free end 77 of the closing member 63 and the side wall portion 30a of the sliding path 30 form the continuous sliding contact surface S.

In other words, the positioning portion 78 located on a width-direction outer side of the sliding path 30 and contacting against the free end 77 of the closing member 63 does not necessarily need a large arrangement space. Thus, according to the above-described configuration, the mountability on the vehicle 1 can be improved.

The cutout portion 60 provided in the side wall portion 30a of the sliding path 30 forms the insertion opening 61 that opens to a lateral side of the guide rail 5, and thereby, the guide rollers 31 can be easily inserted into the sliding path 30. The insertion opening 61 can be easily closed with the closing member 63. Thereby, the superior maintainability can be secured.

The free end 77 of the closing member 63 arranged at the cutout portion 60 forms the sliding contact surface S continuous with the side wall portion 30a of the sliding path 30, and thereby, smooth sliding of the guide rollers 31 is secured, and generation of abnormal noise caused by passing through a step can be suppressed. Thereby, the high silence is secured, and thereby, the quality can be improved.

The formed rotation fulcrum P biases the free end 77 of the closing member 63 in such a way as to contact against the positioning portion 78 located on a width-direction outer side of the sliding path 30, and thereby, the free end 77 can be easily positioned and arranged at a position continuous and contacting with the side wall portion 30a of the sliding path 30. This can facilitate work of closing the insertion opening 61 with the closing member 63.

The positioning portion 78 contacting against the free end 77 of the closing member 63 from a width-direction outer side of the sliding path 30 can support a sliding load of the guide rollers 31 acting on the closing member 63. Thereby, high strength for closing made by the closing member 63 can be secured.

(2) The bracket 62 that is fixed to the guide rail 5 and thereby forms the fixing portion 71 and the positioning portion 78 is provided.

According to the above-described configuration, the fixing portion 71 and the positioning portion 78 are integrated into one body, and thereby, the size can be reduced. Thus, the mountability on the vehicle 1 can be improved. In addition, the assembling work can be facilitated, and strength for holding the closing member 63 can be enhanced.

(3) The closing member 63 includes the vertical wall portion 76 that forms the sliding contact surface S continuous with the side wall portion 30a of the sliding path 30, and the width-direction extending portion 79 that extends from the upper end of the vertical wall portion 76 inward in the width direction of the sliding path 30. The bracket 62 includes the protrusion portion 80 contacting against the distal end 79a of the width-direction extending portion 79. The fulcrum forming portion 81 is configured in such a way as to form the rotation fulcrum P for the closing member 63 at the position where the protrusion portion 80 contacts against the distal end 79a of the width direction-extending portion 79.

According to the above-described configuration, the rotation fulcrum P for the closing member 63 can be formed at the longitudinal-direction position between the fixed end 75 and the free end 77, with the simple configuration. Arranging the fulcrum forming portion 81 on an upper side of the sliding path 30 can save a space in the width direction of the sliding path 30. Thereby, the mountability on the vehicle 1 can be improved.

Providing the protrusion portion 80 in the bracket 62 can simplify a shape of the closing member 63. Thereby, the closing member 63 can be easily formed.

(4) The protrusion portion 80 has a substantially semicircular flat plate shape. The closing member 63 is configured in such a way that the distal end 79a of the width-direction extending portion 79 contacts against the substantially semicircular distal end part set in the protrusion portion 80. Thereby, it can be secured that the closing member 63 smoothly rotates around the rotation fulcrum P formed at the position where the distal end 79a of the width-direction extending portion 79 contacts against the protrusion portion 80.

(5) The guide rail 5 includes the first side wall portion 21 forming the side wall portion 30a that defines the sliding path 30 and at which the cutout portion 60 is provided, the second side wall portion 22 facing the first side wall portion 21, and the upper wall portion 23 connecting the first side wall portions 21 and the second side wall portions 22 to each other. The bracket 62 includes the lateral plate-shaped portion 67 arranged along the upper wall portion 23 of the guide rail 5. The bracket 62 is configured in such a way as to sandwich the width-direction extending portion 79 of the closing member 63 between the lateral plate-shaped portion 67 and the upper wall portion 23 of the guide rail 5.

According to the above-described configuration, the closing member 63 arranged at the cutout portion 60 can be positioned in the up-down direction of the guide rail 5, with the simple configuration, while a space is saved in the width direction of the sliding path 30.

Reaction force in the direction in which the protrusion portion 80 included in the bracket 62 and contacting against the distal end 79a of the width-direction extending portion 79 presses back the width-direction extending portion 79 acts on the width-direction extending portion 79 of the closing member 63. There is a possibility that the reaction force in the direction of pressing back the width-direction extending portion 79 acts in a direction of tilting the vertical wall portion 76 in a form of displacing the upper end portion of vertical wall portion 76 outward in the width direction.

However, as in the above-described configuration, sandwiching the width-direction extending portion 79 of the closing member 63 between the lateral plate-shaped portion 67 of the bracket 62 and the upper wall portion 23 of the guide rail 5 can suppress falling of the closing member 63. Thereby, the reaction force acting on the width-direction extending portion 79 of the closing member 63 can be efficiently converted into biasing force in a direction of displacing the free end 77 of the closing member 63 outward in the width direction of the sliding path 30.

(6) The bracket 62 includes the front-side standing plate-shaped portion 65f as a standing plate-shaped portion that is arranged, on a width-direction outer side of the sliding path 30, along the side wall portion 30a of the sliding path 30 and that thereby forms the positioning portion 78.

According to the above-described configuration, an arrangement space necessary for arranging the positioning portion 78 on a width-direction outer side of the sliding path 30 can be suppressed small. Thereby, the mountability on the vehicle 1 can be improved.

(7) The fixed end 75 of the closing member 63 is fastened to the fixing portion 71 from a width-direction outer side of the sliding path 30, based on fastening force of the screw member 73.

According to the above-described configuration, high strength for holding the closing member 63 can be secured. The fixed end 75 can be fastened to the fixing portion 71, and the free end 77 can be positioned in the width direction of the sliding path 30. This can more facilitate work of closing the insertion opening 61 with the closing member 63.

(8) The center roller unit 12 that is linked to the center rail 11 forming the guide rail 5b on a rear side of the door opening portion 3 is provided with the link member 51 for linking the center roller unit 12 to the drive cable. The link member 51 includes the upward-extending portion 55 including, at the distal end portion 55a, the cable link portion 56 for the drive cable. The upward-extending portion 55 is extended upward in a state of facing the first side wall portion 21 included in the center rail 11 and forming the side wall portion 30a of the sliding path 30, and thereby, the distal end portion 55a is arranged on an upper side of the center rail 11.

In other words, according to the above-described configuration, the link member 51 provided at the center roller unit 12 moves integrally with the center roller unit 12 relative to the center rail 11 along the extending direction of the center rail 1. For this reason, in order to avoid the interference at the time of the relative movement, the upward-extending portion 55 of the link member 51 is arranged apart to a width-direction outer side of the sliding path 30 from the first side wall portion 21 included in the center rail 11 and facing the upward-extending portion 55.

However, by adopting the above-described configurations (1) to (7), an arrangement space for a member protruding to a lateral side of the center rail 11 can be suppressed small even at a position where the insertion opening 61 for the guide rollers 31 is closed with the closing member 63. Thereby, an interval between the upward-extending portion 55 of the link member 51 and the first side wall portion 21 of the center rail 11 that face each other can be shortened. As a result, the effect of improving the mountability on the vehicle 1 can be more remarkably achieved.

The above-described embodiment can be modified and implemented as follows. The above-described embodiment and the following modified examples can be implemented in combination with each other within a range where a technical contradiction does not occur.

In the above-described embodiment, the center rail 11 arranged on a rear side of the door opening 3 is embodied. However, there is no limitation to this, and the application may be made to the upper rail arranged on an upper side of the door opening 3 and the lower rail arranged on a lower side of the door opening 3. The application is not necessarily limited to the guide rail 5 fixed to the vehicle body 2, and may be made to the guide rail 5 fixed to the slide door 4.

In the above-described embodiment, the cutout portion 60 provided in the rear end portion 11r of the center rail 11 forms the insertion opening 61 for the guide rollers 31. However, there is no limitation to this, and the application may be made to a configuration in which the insertion opening 61 for the guide rollers 31 is formed by the cutout portion 60 provided in a front end portion of the guide rail 5.

In the above-described embodiment, the first end portion 60a is the rear-side end portion in the cutout portion 60 in the extending direction of the sliding path 30, the second end portion 60b is the front-side end portion in the cutout portion 60 in the extending direction of the sliding path 30, the fixing portion 71 is arranged at the first end portion 60a, and the positioning portion 78 is arranged at the second end portion 60b. However, there is no limitation to this, and the arranged positions of the fixing portion 71 and the positioning portion 78 may be reversed in a configuration where the cutout portion 60 provided at the front end portion of the guide rail 5 is used as the insertion opening 61 for the guide rollers 31. In other words, the fixing portion 71 to which the fixed end 75 of the closing member 63 is fixed is preferably provided at the end portion of the guide rail 5. Thereby, closing the insertion opening 61 with the closing member 63 enables the longer sliding path 30 for the guide rollers 31 to be secured.

In the above-described embodiment, the bracket 62 is fixed to the guide rail 5, and thereby, the bracket 62 forms the fixing portion 71 and the positioning portion 78. However, there is no limitation to this, and the fixing portion 71 and the positioning portion 78 may be formed by respective independent separate members. In addition, the shapes may be arbitrarily modified. However, from the viewpoint of space saving, the preferable external shapes are flat plate shapes standing along the side wall portion 30a of the sliding path 30, such as a shape of the first standing plate-shaped portion 65 in the above-described embodiment.

In the above-described embodiment, the fixed end 75 of the closing member 63 is fastened to the fixing portion 71 from a width-direction outside of the sliding path 30, based on fastening force of the screw member 73. However, there is no limitation to this, and a structure of fixing the fixed end 75 to the fixing portion 71 may be arbitrarily modified and be a structure of welding or adhesion, for example.

In the above-described embodiment, the closing member 63 includes the vertical wall portion 76 having an external shape of a long flat plate and arranged at the cutout portion 60, thereby forming the sliding contact surface S continuous with the side wall portion 30a of the sliding path 30. The closing member 63 includes the width-direction extending portion 79 having an external shape of a substantially flat plate extending inward in the width direction of the sliding path 30 from the upper end of the vertical wall portion 76. The distal end 79a of the width-direction extending portion 79 contacts against the protrusion portion 80 provided in the lateral plate-shaped portion 67 of the bracket 62, and thereby, the rotation fulcrum P for the closing member 63 is formed at this contacted position. The protrusion portion 80 forms the fulcrum forming portion 81.

However, there is no limitation to this, and for example, the protrusion portion 80 is provided in the width-direction extending portion 79 of the closing member 63. This protrusion portion 80 may contact against the lateral plate-shaped portion 67 of the bracket 62, and thereby, the rotation fulcrum P for the closing member 63 may be formed. The fulcrum forming portion 81 is formed in such a way that the protrusion portion 80 provided in one of the closing member 63 and the bracket 62 contacts against the other of the closing member 63 and the bracket 62, thereby forming the rotation fulcrum P for the closing member 63. A shape and an arranged position of the protrusion portion 80 may also be arbitrarily modified.

The fulcrum forming portion 81 does not necessarily need to include the protrusion portion 80 such as that in the above-described embodiment. An independent separate member different from the bracket 62 may form the fulcrum forming portion 81. For example, a part of the guide rail 5 may form the fulcrum forming portion 81.

A shape of the closing member 63 may also be arbitrarily modified. However, from the viewpoint of saving a space and forming the sliding contact surface S continuous with the side wall portion 30a of the sliding path 30, the closing member 63 preferably has a flat plate shape, such as that of the vertical wall portion 76 in the above-described embodiment, arranged in such a way as to be continuous and contacting with the side wall portion 30a of the sliding path 30.

In the above-described embodiment, the bracket 62 includes the lateral plate-shaped portion 67 arranged along the upper wall portion 23 of the guide rail 5. The width-direction extending portion 79 of the closing member 63 is sandwiched between the lateral plate-shaped portion 67 and the upper wall portion 23 of the guide rail 5. Thereby, the closing member 63 arranged at the cutout portion 60 is positioned in the up-down direction of the guide rail 5, and falling of the closing member 63 is suppressed.

However, there is no limitation to this, and a structure of positioning the closing member 63 in the up-down direction of the guide rail 5 may be arbitrarily modified. A structure of suppressing falling of the closing member 63 may also be arbitrarily modified, for example, into a structure where an engagement protrusion portion provided in one of the closing member 63 and the bracket 62 is engaged with an engagement recess portion provided in the other of the closing member 63 and the bracket 62.

The slide door apparatus 10 is configured as the power slide door apparatus 50 in the above-described embodiment, but may be applied to a manual type apparatus.

A vehicular slide door apparatus that solves the above-described problem includes a guide rail. The guide rail forms a sliding path extending in an opening-closing operation direction of a slide door, and guides, in an extending direction of the sliding path, a guide roller arranged in the sliding path. A cutout portion provided in a side wall portion of the sliding path forms an insertion opening to the sliding path, for the guide roller. The vehicular slide door apparatus includes a fixing portion, a positioning portion, a closing member, and a fulcrum forming portion. The fixing portion is arranged at a first end portion in the cutout portion in the extending direction. The positioning portion is arranged at a second end portion in the cutout portion in the extending direction. The closing member includes a fixed end fixed to the fixing portion and a free end positioned by the positioning portion, and is arranged at the cutout portion, thereby closing the insertion opening. The fulcrum forming portion forms a rotation fulcrum for the closing member at a longitudinal-direction position between the fixed end and the free end by fixing of the fixed end to the fixing portion. The fulcrum forming portion generates biasing force in a direction of displacing the free end outward in a width direction of the sliding path. The free end of the closing member is positioned in contact against the positioning portion located on a width-direction outer side of the sliding path. Thereby, the free end of the closing member and the side wall portion of the sliding path are configured to form a continuous sliding contact surface for the guide roller.

In other words, a large arrangement space is not necessarily needed for the positioning portion located on a width-direction outer side of the sliding path and contacting against the free end of the closing member. Thus, according to the above-described configuration, mountability on a vehicle can be improved.

The vehicular slide door apparatus may include a bracket that forms the fixing portion and the positioning portion by being fixed to the guide rail.

According to the above-described configuration, the fixing portion and the positioning portion are integrated into one body, and thereby, the size can be reduced. Thereby, the mountability on a vehicle can be improved. In addition, assembling work can be facilitated, and strength for holding the closing member can be enhanced.

In the vehicular slide door apparatus, the fulcrum forming portion may include a protrusion portion that is provided in one of the closing member and the bracket and that contacts against another of the closing member and the bracket, thereby forming the rotation fulcrum.

According to the above-described configuration, the rotation fulcrum for the closing member can be formed at the longitudinal-direction position between the fixed end and the free end, with a simple configuration.

In the vehicular slide door apparatus, the closing member may include a vertical wall portion and a width-direction extending portion. The vertical wall portion may form the sliding contact surface continuous with the side wall portion of the sliding path. The width-direction extending portion may extend from an upper end of the vertical wall portion inward in the width direction of the sliding path. The protrusion portion may be provided, in the bracket, at a position contacting against a distal end of the width-direction extending portion.

According to the above-described configuration, arranging the fulcrum forming portion on an upper side of the sliding path enables a space to be saved in the width direction of the sliding path. Thereby, the mountability on a vehicle can be improved.

In the vehicular slide door apparatus, the guide rail may include a first side wall portion, a second side wall portion, and an upper wall portion. The first side wall portion may form the side wall portion defining the sliding path and being provided with the cutout portion. The second side wall portion may face the first side wall portion. The upper wall portion may connect the first side wall portion and the second side wall portion to each other. The bracket may include a lateral plate-shaped portion arranged along the upper wall portion of the guide rail. The bracket may be configured in such a way as to sandwich the width-direction extending portion of the closing member between the lateral plate-shaped portion and the upper wall portion of the guide rail.

According to the above-described configuration, the closing member arranged at the cutout portion can be positioned in an up-down direction of the guide rail, with a simple configuration, while a space is saved in the width direction of the sliding path. In addition, falling of the closing member can be suppressed. Thereby, reaction force acting on the width-direction extending portion of the closing member can be efficiently converted into biasing force in a direction of displacing the free end of the closing member outward in the width direction of the sliding path.

In the vehicular slide door apparatus, the bracket may include a standing plate-shaped portion that forms the positioning portion by being arranged along the side wall portion and on a width-direction outer side of the sliding path.

According to the above-described configuration, an arrangement space necessary for arranging the positioning portion on a width-direction outer side of the sliding path can be suppressed small. Thereby, the mountability on a vehicle can be improved.

In the vehicular slide door apparatus, the fixed end of the closing member may be fastened to the fixing portion from a width-direction outer side of the sliding path, based on fastening force of a screw member.

According to the above-described configuration, high strength for holding the closing member can be secured. Further, the fixed end can be fastened to the fixing portion, and the free end can be positioned in the width direction of the sliding path. This can facilitate work of closing the insertion opening with the closing member.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A vehicular slide door apparatus comprising a guide rail that forms a sliding path extending in an opening-closing operation direction of a slide door and that guides, in an extending direction of the sliding path, a guide roller arranged in the sliding path, wherein a cutout portion provided in a side wall portion of the sliding path forms an insertion opening to the sliding path, for the guide roller,
the vehicular slide door apparatus comprises:
a fixing portion arranged at a first end portion in the cutout portion in the extending direction;
a positioning portion arranged at a second end portion in the cutout portion in the extending direction;
a closing member that includes a fixed end fixed to the fixing portion and a free end positioned by the positioning portion and that is arranged at the cutout portion, thereby closing the insertion opening; and
a fulcrum forming portion that forms a rotation fulcrum for the closing member at a longitudinal-direction position between the fixed end and the free end by fixing of the fixed end to the fixing portion, and that generates biasing force in a direction of displacing the free end on a width-direction outer side of the sliding path, and
the free end of the closing member is positioned in contact against the positioning portion located on a width-direction outer side of the sliding path, and thereby, the free end of the closing member and the side wall portion of the sliding path are configured to form a continuous sliding contact surface for the guide roller.

2. The vehicular slide door apparatus according to claim 1, further comprising a bracket that forms the fixing portion and the positioning portion by being fixed to the guide rail.

3. The vehicular slide door apparatus according to claim 2, wherein
the fulcrum forming portion includes a protrusion portion that is provided in one of the closing member and the bracket and that contacts against another of the closing member and the bracket, thereby forming the rotation fulcrum.

4. The vehicular slide door apparatus according to claim 3, wherein
the closing member includes: a vertical wall portion that forms the sliding contact surface continuous with the side wall portion of the sliding path; and a width-direction extending portion that extends from an upper end of the vertical wall portion inward in the width direction of the sliding path, and
the protrusion portion is provided, in the bracket, at a position contacting against a distal end of the width-direction extending portion.

5. The vehicular slide door apparatus according to claim 4, wherein
the guide rail includes:
a first side wall portion that forms the side wall portion defining the sliding path and being provided with the cutout portion;
a second side wall portion facing the first side wall portion; and
an upper wall portion connecting the first side wall portion and the second side wall portion to each other, and
the bracket includes a lateral plate-shaped portion arranged along the upper wall portion of the guide rail, and is configured in such a way as to sandwich the width-direction extending portion of the closing member between the lateral plate-shaped portion and the upper wall portion of the guide rail.

6. The vehicular slide door apparatus according to claim 2, wherein
the bracket includes a standing plate-shaped portion that forms the positioning portion by being arranged along the side wall portion and on a width-direction outer side of the sliding path.

7. The vehicular slide door apparatus according to claim 1, wherein
the fixed end of the closing member is fastened to the fixing portion from a width-direction outer side of the sliding path, based on fastening force of a screw member.
